(19) United States
(12) Patent Application Publication
(10) Pub. No.: US 2013/0323975 A1
(43) Pub. Date: Dec. 5, 2013

(54) PORTABLE DATA STORAGE DEVICE

(71) Applicants: Wang-I YU, Jhonghe (TW); Hung-Chi TAI, Jhonghe (TW); Yong-Gang ZHANG, Taicang (CN)

(72) Inventors: Wang-I YU, Jhonghe (TW); Hung-Chi TAI, Jhonghe (TW); Yong-Gang ZHANG, Taicang (CN)

(73) Assignee: ALLTOP ELECTRONICS (SUZHOU) LTD., Taicang City (CN)

(21) Appl. No.: 13/585,490

(22) Filed: Aug. 14, 2012

(30) Foreign Application Priority Data
May 30, 2012 (CN) 201210172384.6

(51) Int. Cl. H01R 13/66

(52) U.S. Cl. 439/620.21

(57) ABSTRACT

A portable data storage device has a shell, an integrated circuit (IC) received in the shell, and a plug connecting with the IC. The plug includes an insulating housing partially extending out of the shell, a shield enclosing the insulating housing, and a number of contacts assembled to the insulating housing. The shield defines a first receiving space and a second receiving space. The first receiving space communicates with the second receiving space via a communicating hole.

### BACKGROUND OF THE INVENTION

1. Field of the Invention

The present invention relates to a data storage device, and more particularly to a portable data storage device.

2. Description of Related Art

USB connectors are widely used in digital products including computer, digital camera, or portable communications terminals. With the development of the technology, the USB connector is updated from 2.0 version to 3.0 version and the corresponding transmission rate is updated from 480 Mbps up to 3.2 Gbps. Nowadays, portable devices such as laptops and cellular phones are designed more and more compact to facilitate the storage and carrying thereof. Therefore, Micro-USB connectors are developed and are more compact when compared to the USB 3.0 connectors so that the Micro-USB 3.0 connectors may be easily assembled on the portable electronic devices.

Hence, it is desirable to provide a portable data storage device with Micro USB 3.0 interface.

### BRIEF SUMMARY OF THE INVENTION

In order to achieve the above-mentioned object, a portable data storage device in accordance with the present invention has a shell, an integrated circuit (IC) received in the shell, and a plug connecting with the IC. The plug includes an insulating housing partially extending out of the shell, a shield enclosing the insulating housing, and a number of contacts assembled to the insulating housing. The shield defines a first receiving space and a second receiving space. The first receiving space communicates with the second receiving space via a communicating hole.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a portable data storage device in accordance with the present invention;

FIG. 2 is an exploded, perspective view of the portable data storage device of FIG. 1;

FIG. 3 is a perspective view of a plug of the portable data storage device shown in FIG. 1;

FIG. 4 is an exploded, perspective view of the plug shown in FIG.

3; and

FIG. 5 is a view similar to FIG. 4, while taken from another aspect.

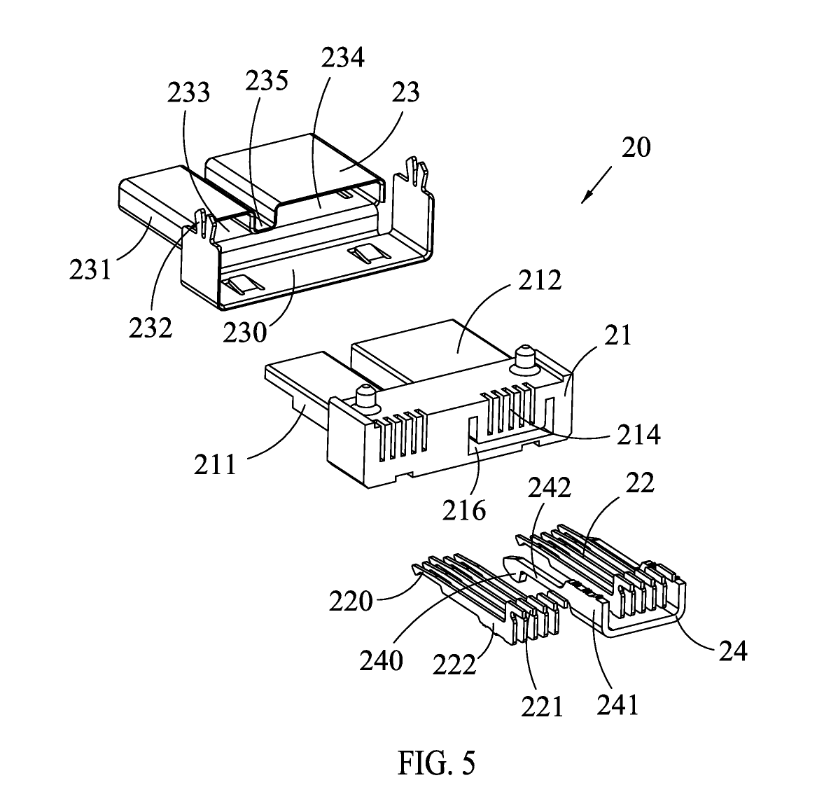

### DETAILED DESCRIPTION OF THE PREFERRED EMBODIMENT

Reference will be made to the drawing figures to describe the present invention in detail, wherein depicted elements are not necessarily shown to scale and wherein like or similar elements are designated by same or similar reference numeral through the several views and same or similar terminology.

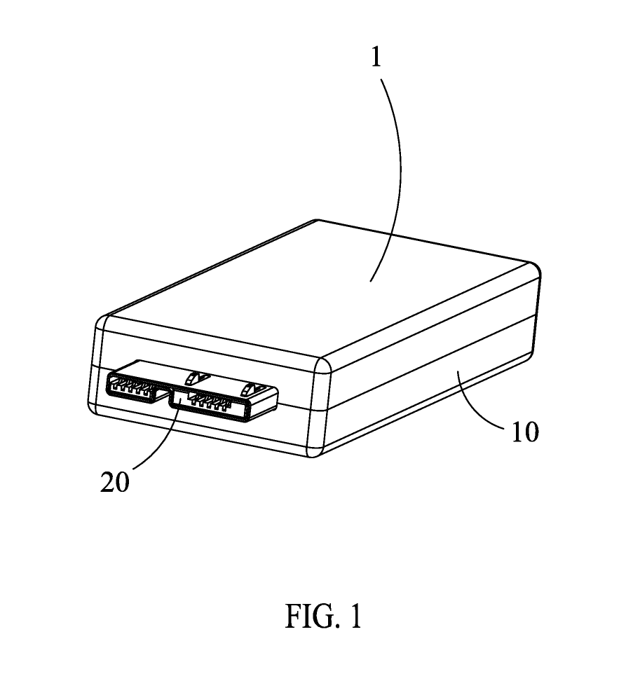

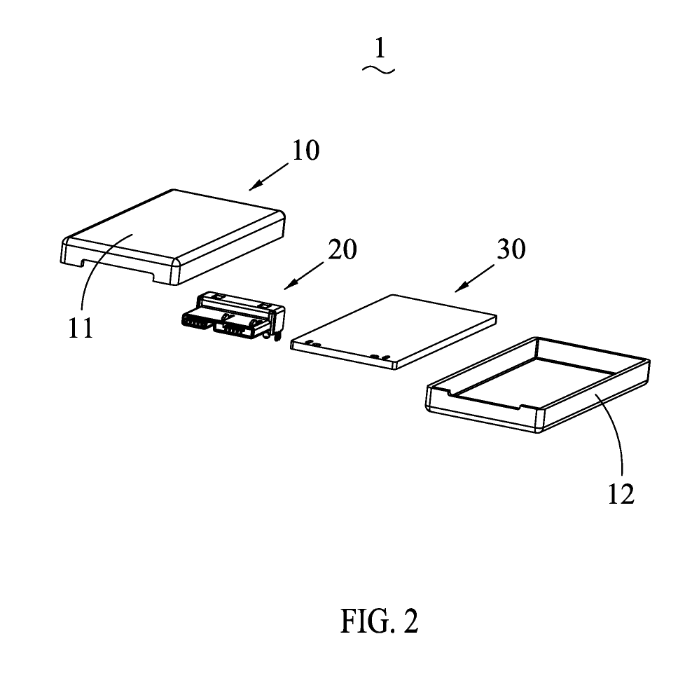

Referring to FIGS. 1-2, a portable data storage device 1 in accordance with the present invention comprises a shell 10, a plug 20 partially received in the shell 10 and an integrated circuit (IC) 30 received in the shell 10. The IC 30 is used to storage the data. The shell 10 includes a top shell 11 and a bottom shell 12 assembled with the top shell 11. As can be understood, in other embodiment, the shell 10 can also be insert-molded in the plug 20 and the device 1. In the preferred embodiment, the plug 20 is compliance with the Micro USB 3.0 standard.

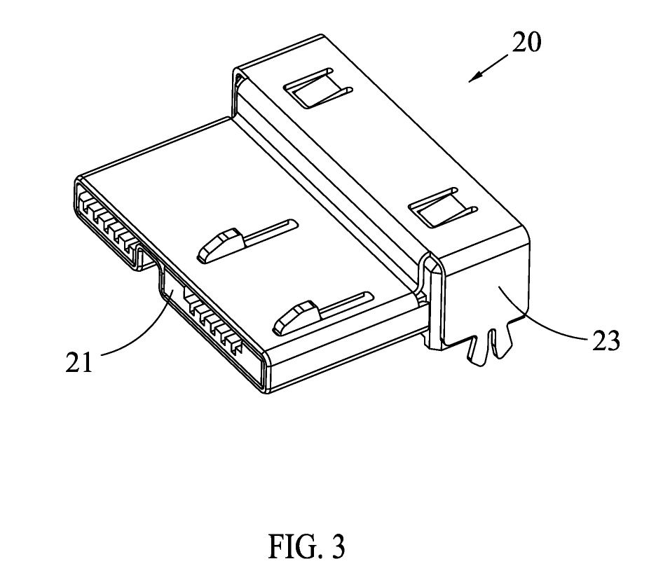

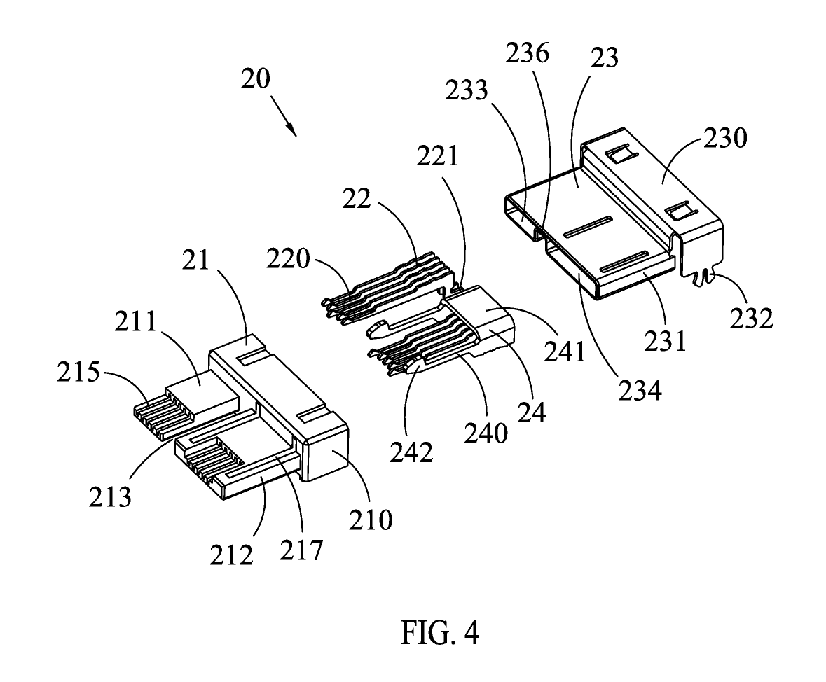

Please referring to FIGS. 3-4, the plug 20 comprises an insulating housing 21, a plurality of contacts 22 received in the insulating housing 21, a shield 23 covering the insulating housing 21 and the contacts 22, and a U-shaped grounding contact 24 assembled in the insulating housing 21.

The insulating housing 21 comprises a main portion 210, a first tongue portion 211 and a second tongue portion 212 extending side by side from the main portion 210. The thickness of the main portion 210 is larger than the thickness of the first tongue portion 211 and the second tongue portion 212. A slot 213 is defined between the first tongue portion 211 and the second tongue portion 212. The main portion 210 defines a plurality of receiving channels 214. The first tongue portion 211 and the second tongue portion 212 each define a plurality of receiving passageways 213. Each receiving channel 214 communicates with a corresponding receiving passageway 213 for respectively receiving the contact 22. The front section of the receiving passageway 215 is partially exposed to the outside. The main portion 210 of the insulating housing 21 defines a U-shaped slit 216. The second tongue portion 212 provides a pair of locking grooves 217 communicating with the U-shaped slit 216. The pair of locking grooves 217 is located at opposite sides of the receiving passageways 215.

The contacts 22 are divided into two groups which is respectively assembled to the first tongue portion 211 and the second tongue portion 212. Each contact 22 comprises a contacting portion 220, a soldering portion 221 and a connecting portion 222 connecting the contacting portion 220 and the soldering portion 221. The contacting portion 220 is received in corresponding receiving passageway 215. The connecting portion 222 extends through the first tongue portion 211/the second tongue portion 212 and the main portion 210. The soldering portion 221 extends from the receiving channel 214 of the main portion 210 and electrically connects with the IC 30.

The U-shaped grounding contact 24 is assembled on the second tongue portion 212, which comprises a contacting portion 240 and a U-shaped retaining portion 241. The contacting portion 240 has a pair of contacting fingers 242 extending from opposite sides of the U-shaped retaining portion 241. The pair of contacting fingers 242 is correspondingly received in the locking grooves 217. The U-shaped retaining portion 241 is received in the U-shaped slit 216 of the main portion 210 of the insulating housing 21.

The shield 23 is formed from one piece of metal sheet, which comprises a base portion 230 and a mating portion 231 extending forwardly from the base portion 230. As in other embodiment, the shield 23 can be assembled by pieces of elements. A pair of grounding tails 232 extends perpendicularly from the base portion 230 for inserting into through holes (not shown) of the IC 30. The mating portion 231 defines a pair of receiving spaces including a first receiving space 233 and a second receiving space 234. The first receiving space 233 receives therein the first tongue portion 211 and the second receiving space 234 receives therein the second tongue portion 212. The shield 23 provides a protrusion 235 extending into the slot 213 between the first tongue portion 211 and the second tongue portion 212. A communicating hole 216 is thus defined next to the protrusion 235 and interconnects the first receiving space 233 and the second receiving space 234. In the preferred embodiment, the protrusion 235 has a substantial U-shaped cross section. Understandably, the cross-section of the protrusion 235 can also be other structures or shapes.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A portable data storage device, comprising:
a shell;
an integrated circuit received in the shell; and
a plug electrically connecting with the integrated circuit, the plug comprising an insulating housing partially extending out of the shell, a shield enclosing the insulating housing, and a plurality of contacts assembled to the insulating housing;
wherein the shield defines a first receiving space and a second receiving space, and wherein the first receiving space communicates with the second receiving space via a communicating hole.

2. The portable data storage device as claimed in claim 1, wherein the insulating housing comprises a main portion assembled in the shell, a first tongue portion and a second tongue portion extending from the main portion, and wherein the first tongue portion is received in the first receiving space and the second tongue portion is received in the second receiving space.

3. The portable data storage device as claimed in claim 2, wherein a slot is defined between the first tongue portion and the second tongue portion.

4. The portable data storage device as claimed in claim 3, wherein the shield provides a protrusion extending into the slot and the communicating hole is defined next to the protrusion.

5. The portable data storage device as claimed in claim 2, wherein the thickness of the main portion is larger than that of the first tongue portion and the second tongue portion.

6. The portable data storage device as claimed in claim 5, wherein the first tongue portion and the second tongue portion each define a plurality of receiving passageways for receiving the contacts.

7. The portable data storage device as claimed in claim 6, wherein the main portion of the insulating housing defines a plurality receiving channels, each receiving channel communicating with corresponding receiving passageway.

8. The portable data storage device as claimed in claim 2, wherein the plug comprises a U-shaped grounding contact, and wherein the U-shaped grounding contact has a U-shaped retaining portion and a contacting portion.

9. The portable data storage device as claimed in claim 8, wherein the contacting portion comprises a pair of contacting fingers extending from the U-shaped retaining portion.

10. The portable data storage device as claimed in claim 9, wherein the main portion of the insulating housing defines a U-shaped slit for receiving the U-shaped retaining portion.

11. The portable data storage device as claimed in claim 1, wherein the plug is compliance with Micro USB 3.0 standard.
